(19) United States
(12) Patent Application Publication
(10) Pub. No.: US 2007/0248811 A1
(43) Pub. Date: Oct. 25, 2007

(54) PROJECTION SCREEN

(76) Inventor: Yao Hwong, Tustin, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/734,708

(22) Filed: Apr. 12, 2007

Related U.S. Application Data
(60) Provisional application No. 60/794,283, filed on Apr. 21, 2006.

(51) Int. Cl. B32B 27/20; B32B 27/36; B05D 5/06

(52) U.S. Cl. 428/323; 428/412; 428/480; 428/337; 427/163.3

(57) ABSTRACT

A surface of a substrate is coated with a mixture of substantially planar irregular shaped pigments and a clear non-colored adhesive liquid. The pigments are efficient in both reflection (off the substantially planar surface) and refraction (from the irregular shaped edges). The substrate is coated, such that wash outs do not occur due to white or grey color in the coating or screen surface. A glare reducing material can be mixed in with the coating, which both reflects and refracts light, or the material can be applied as a separate layer.

### CROSS REFERENCE TO RELATED APPLICATIONS

This application claims benefit to U.S. Provisional Pat. Appl. Ser. No. 60/794,283, filed Apr. 21, 2006, which is incorporated by reference in its entirety.

### BACKGROUND

1. Field of Invention

The present invention relates to projection screens and methods of making projection screens.

2. Related Art

In general, a projection display can be divided into a front projection type screen and a rear projection type screen. In the front projection type screen, an image is projected from a projector onto the front projection type screen. The image is displayed on the screen. The size of the front projection type screen is typically much greater than the rear projection type screen. In contrast, the rear projection type screen, which is usually adopted in typical projection televisions exhibits, provides superior image quality compared to the front projection type.

Conventional front projection screens typically have a smooth white coating on the screen surface that reflects incident light from the projector in all directions in a substantially uniform manner. With such a screen, the viewing angle increases while brightness of the screen decreases. Another type of screen has glass beads or other similar structures distributed and coated on a screen surface. Incident light is reflected at an angle from the glass beads and the resulting image is brighter within a limited viewing distance. However, because light is reflected at different angles, the brightness and quality uniformity may not be uniform at different viewing angles and distances. Also, diffused reflection occurs as disturbance light overlaps the light emitted from a projector, resulting in reduced contrast levels.

Furthermore, standard projection screens on the market today are coated with a colored coating (or non-transparent), such as white or gray. In high ambient light environments, a white screen surface practically filters all projected images with a white color. In general, the effect is called a “wash out”. Similarly, a gray color-coated screen surface filters all projected images with a gray color, resulting in a degraded image, such as lower brightness, contrast, and/or color.

Therefore, there is a need for a projection screen that overcomes the disadvantages as discussed above with conventional projection screens providing higher image fidelity in various ambient light conditions.

### SUMMARY

According to one aspect of the present invention, a projection screen includes a coating of irregularly-shaped flakes or pigments adhered to a substrate. The flakes both reflect and refract light. The flakes are approximately planar or flat in one embodiment. The flakes are mixed with a non-colored, clear adhesive, resulting in an imaging layer or coating that can reflect and refract light, with the amount of refraction and reflection depending on the shape of flakes. In one embodiment, imaging layer is applied to the back of a substrate. An anti-glare coating, such as a LEXAN® matte film (e.g., 8A13F or 8B35) from GE, is applied to the top of the substrate. In a second embodiment, the flakes are mixed with a clear adhesive and a matting or glare-reducing agent, such as wax, and then applied to the front of the substrate. In a third embodiment, the imaging layer is applied to the front of a substrate. An anti-glare or matte film/coating is then applied on the imaging layer.

The flakes can be aluminum or other reflective material. In one embodiment, the flakes have a high degree of irregularity, e.g., shaped like a “corn flake” with many irregular-shaped protrusions. In another embodiment, the flakes are more orderly, e.g., a more curved or rounded shape, with less irregular-shaped protrusions. If the flakes are more irregular, refraction increases, while more regularly shaped flakes have higher reflection. Thus, the imaging layer or coating can be formed with one type of flake or a combination of two or more different types, depending on screen requirements and desired reflection to refraction ratios. The density of the flake or flakes can also be varied to alter the reflection to refraction ratio.

Another aspect of the present invention provides methods for making a projection screen. In one embodiment, the irregularly-shaped flakes are first mixed with a clear adhesive to form an imaging layer or coating. The imaging layer is then coated onto a back of a transparent substrate. An anti-glare or matte film/coating is formed on the front of the substrate.

In another embodiment, the flakes are mixed with the clear adhesive and an anti-glare agent, such as wax or other industrial matting agents. The resulting mixture is then coated onto the front of the substrate.

In yet another embodiment, the flakes are mixed with the clear adhesive and coated onto the front of the substrate. An anti-glare material or matte film is then formed or deposited or coated over the layer of flakes.

Due to the shape of the flakes, the imaging layer formed by the flakes reflect as well as refract maximum intensity of the projected image, so that the maximum gain and contrast of projected images can be viewed with optimum quality without using a colored coating such as white or gray. Thus, such a projection screen enables the projected image to be seen in high ambient light environment in its original form, as well as providing the optimal color fidelity and view angle. The reflectivity and refractivity of the projection screen can be optimized by adjusting the density and mixing ratio of different types or shapes of the flakes and applying various light processing treatments to the coating surface without using a colored coating such as white or gray.

This invention will be more fully understood in light of the following detailed description taken together with the accompanying drawings.

### BRIEF DESCRIPTION OF THE DRAWINGS

FIGS. 1A-1C show three types of flakes for forming an imaging layer or film according to different embodiments.

FIGS. 2A and 2B are side sectional views of steps to manufacture a projection screen according to one embodiment.

FIG. 3 is a side sectional view of a projection screen according to one embodiment.

FIGS. 4A and 4B are side sectional views of steps to manufacture a projection screen according to another embodiment.

FIGS. 5A and 5B are side sectional views of steps to manufacture a projection screen according to another embodiment.

It should be appreciated that like reference numerals are used to identify like elements illustrated in one or more of the figures.

### DETAILED DESCRIPTION

According to one aspect of the invention, irregularly-shaped flakes, which are approximately planar or flat, are mixed with an adhesive to form an imaging layer or coating for a projection screen. The flakes can be aluminum or any other suitable material that both reflects and refracts light.

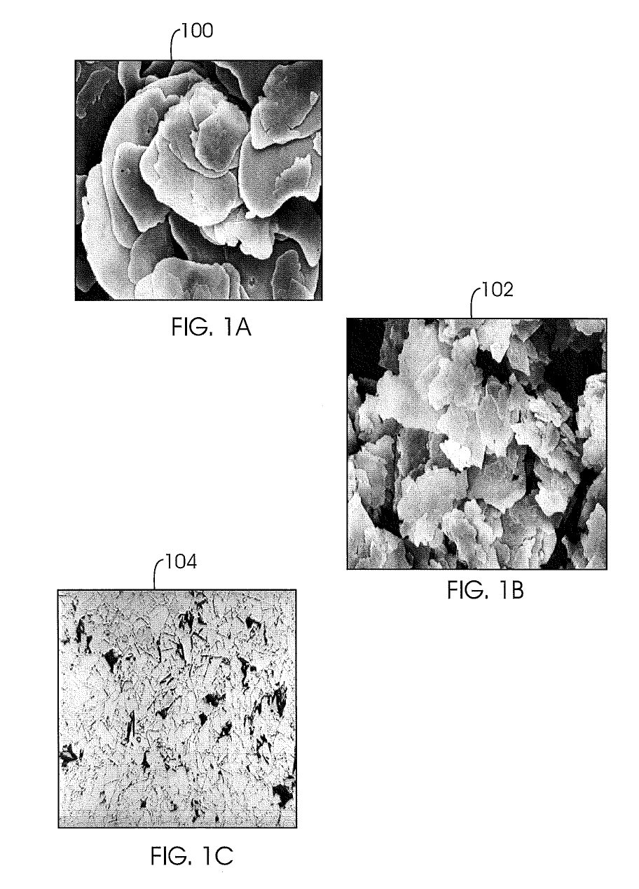

FIG. 1A shows one type of flake 100 suitable for use. Flakes 100 have a relatively smooth contour, with a low occurrence of irregular protrusions. One suitable type of flake is the “silver dollar” pigment from the Alushine Series from Schlenk Metallpulver GmbH & Co. KG of Germany.

FIG. 1B shows a second type of flake 102 that is also suitable for use. Flakes 102 have a more irregular shape than flakes 100 and have more irregular protrusions along its outer edges. One suitable type of flake 102 is the “corn flake” pigment from the Alucar Series from Schlenk.

FIG. 1C shows a third type of flake 104 that can be used in the present invention. Flakes 104 are vacuum metallized pigments (or VMP), which are commonly known in the art. VMP flakes provide different reflection and refraction characteristics from “silver dollar” pigments or “corn flake” pigments. Typically, they have a high reflection to refraction ratio, resulting in the pigments behaving more like a mirror than a screen. However, depending on system requirements, a manufacturer may want to use VMP flakes.

In one embodiment, the flakes range in size between approximately 8 and 35 microns. The surface of the flakes can be polished, such that impinging light is highly reflected from the surface. The irregular edges of the flakes enable light to be refracted. As the edges become more irregular, refraction increases, but reflection decreases. Thus, depending on screen requirements, a mixture of all “snowflake” pigments, all “corn flake” pigments, all VMP pigments, or a mixture of these or other types of flakes in various compositions and densities can be used to manufacture the projection screen.

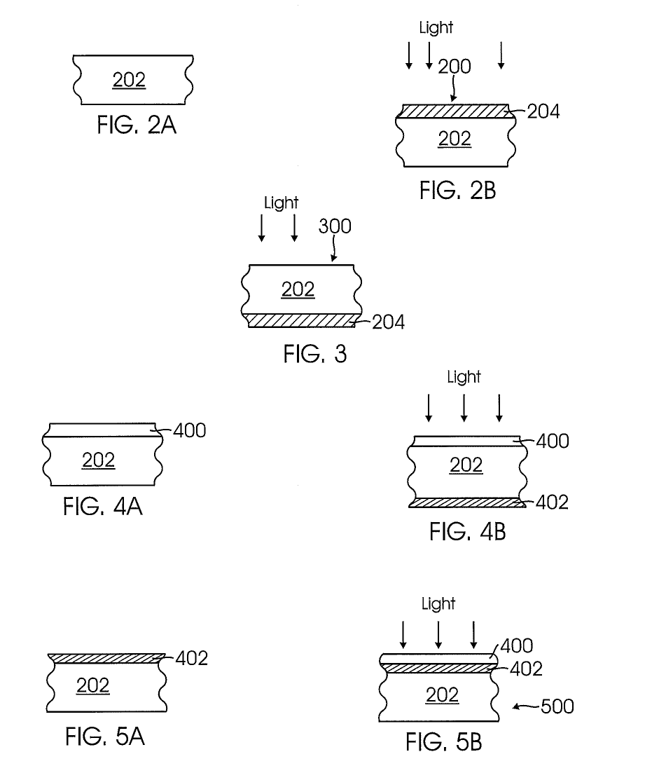

FIGS. 2A and 2B are side sectional views showing processing steps in manufacturing a projection screen 200 according to one embodiment. First, in FIG. 2A, a substrate 202 is provided, which can be either a clear or non-clear material. In one embodiment, the substrate is formed of a polycarbonate resin thermoplastic, such as Lexan® from GE Plastics, and in particular, Lexan® 8A13F or 8B35. In other embodiments, the material can be polyester or vinyl banner. The thickness of substrate 202 can vary, depending on screen and system requirements. Obviously, a thinner substrate will be lighter, but maybe not as sturdy. In one embodiment, the thickness ranges between approximately 0.005″ and 0.025″, although other thicknesses may also be suitable.

Next, an imaging layer or coating 204 is applied on the front surface of substrate 202. Application can be by any suitable process, such as, but not limited to, vacuum deposition or a granure cylindrical printing, or screen printing, or an inkjet printing process. In one embodiment, imaging coating 204 is manufactured by mixing the flakes described above with a clear (e.g., non-colored) bonding agent or adhesive and a glare reducing agent. For the clear adhesive, a clear overprint, such as the PD-C50 or PD-E50 from Coates Screen of St. Charles, Ill., can be used, such as for coating a polycarbonate substrate with UV curing. A clear vinyl banner ink, such as the VYB-E50 from Coates Screen, for a vinyl banner substrate. For the glare reducing agent, a wax or any other suitable industrial matting agent can be used.

In one embodiment, the flakes are first mixed with the clear adhesive, with a ratio, by weight of 10% to 25% flake to adhesive. In one embodiment, the ratio is approximately 17% by weight. Next, the glare reducing agent is mixed in. In one embodiment, the amount is 5% to 30% by weight, such as 20%. This results in coating 204 that is reflective, refractive, and glare reducing. This mixture can then be applied to the front surface of substrate 202, resulting in projection screen 200 in FIG. 2B. In the case of coating with screen-printing process, a printing screen-mesh of 300 or in the range of 190 to 400 mesh is used.

The imaging layer 204 can also be applied to the back surface of substrate 202 in another embodiment of a projection screen 300, as shown in FIG. 3.

FIGS. 4A and 4B are steps showing manufacture of another embodiment of the present invention. In FIG. 4A, substrate 202 is first provided. Substrate 202 can be provided with a matte or smooth surface, such as the 8A13F or 8B35 Lexan products from GE Plastics, or a glare reducing coating 400 can be applied to the front surface of substrate 202. Glare reducing coating 400 can be any conventional anti-glare or matting layer whether extruded, pressed on or coated. In FIG. 4B, a mixture 402 of the flakes and clear adhesive is formed on the back surface of substrate 202, such as described above, but without the glare reducing agent. Mixture 402 is both refracting and reflecting. If glare reduction coating 400 is formed on front surface of substrate 202, the order of formation can be before or after forming mixture 402 on the back surface.

FIGS. 5A and 5B are side views showing a process for manufacturing a projection screen 500 according to another embodiment. In FIG. 5A, mixture 402 is applied to the front surface of substrate 202. Next, a matte or glare reducing coating 400 is applied to mixture 402, resulting in projection screen 500.

Projection screens of the present invention utilize a reflective/refractive coating comprised of substantially planar irregular shaped pigments or flakes, which provide both high reflectivity and refractivity. The pigments cover the substrate so that disadvantages associated with colored coating, such as white or gray, are not present with this projection screen. Flexibility is also increased, as the manufacturer can adjust the density and/or type of pigment according to desired performance requirements of the screen. For example, using a majority or all of the “silver dollar” pigments results in a screen with higher reflectivity. Viewing angle can also be increased due to the refractivity of the screen.

Having thus described embodiments of the present invention, persons skilled in the art will recognize that changes may be made in form and detail without departing from the scope of the invention. Thus the invention is limited only by the following claims.

What is claimed is:

1. A projection screen, comprising:
a substrate having a first side and an opposing second side; and
an imaging coating on the first side, wherein the imaging coating comprises:
a plurality of substantially planar irregular shaped pigments that both reflect and refract light; and
a clear non-colored adhesive liquid.

2. The screen of claim 1, wherein the substrate is a polycarbonate or polyester film.

3. The screen of claim 1, wherein the substrate is between approximately 0.005 and 0.025 inches thick.

4. The screen of claim 1, wherein the pigments are all of a single type of pigment.

5. The screen of claim 1, wherein the pigments are of two or more different types of pigments.

6. The screen of claim 1, wherein the pigments are aluminum.

7. The screen of claim 1, wherein the imaging coating further comprises an anti-glare material.

8. The screen of claim 1, wherein the weight ratio of the pigments to the adhesive liquid is in the range of 10% to 25%.

9. The screen of claim 7, wherein the weight ratio of the pigments to the adhesive liquid is in the range of 10% to 25% and the weight ratio of the anti-glare material to the pigment/liquid mixture is in the range of 5% to 30%.

10. The screen of claim 1, wherein the first side is incident to projected light.

11. The screen of claim 8, further comprising an anti-glare layer formed over the imaging coating.

12. The screen of claim 1, wherein the second side is incident to projected light.

13. The screen of claim 12, further comprising an anti-glare layer formed over the first side.

14. The screen of claim 12, wherein the substrate has an anti-glare top surface.

15. The screen of claim 1, wherein the pigments range in size from 8 microns to 33 microns.

16. The screen of claim 1, wherein the substrate is transparent.

17. The screen of claim 1, wherein the substrate is non-transparent.

18. A method of forming a projection screen, comprising:
providing a substrate having a first side and an opposing second side;
mixing substantially planar irregular shaped pigments with a clear non-colored adhesive liquid, wherein the pigments reflect and refract light; and
applying the mixture to the first side of the substrate.

19. The method of claim 18, wherein the substrate is a polycarbonate or polyester film.

20. The method of claim 18, wherein the substrate is between approximately 0.005 and 0.025 inches thick.

21. The method of claim 18, wherein the pigments are all of a single type of pigment.

22. The method of claim 18, wherein the pigments are of two or more different types of pigments.

23. The method of claim 18, wherein the pigments are aluminum.

24. The method of claim 18, further comprising mixing an anti-glare material into the mixture.

25. The method of claim 18, wherein the weight ratio of the pigments to the adhesive liquid is in the range of 10% to 25%.

26. The method of claim 24, wherein the weight ratio of the pigments to the adhesive liquid is in the range of 10% to 25% and the weight ratio of the anti-glare material to the pigment/liquid mixture is in the range of 5% to 30%.

27. The method of claim 18, wherein the first side is incident to projected light.

28. The method of claim 27, further comprising forming an anti-glare layer over the mixture.

29. The method of claim 18, wherein the second side is incident to projected light.

30. The method of claim 29, further comprising forming an anti-glare layer formed over the first side.

31. The method of claim 29, wherein the substrate has a matte top surface.

32. The method of claim 18, wherein the pigments range in size from 8 microns to 33 microns.

33. The method of claim 18, wherein the substrate is transparent.

34. The method of claim 18, wherein the substrate is non-transparent.

35. The method of claim 18, wherein the applying is with a mesh screen.
